(19) United States
(12) Patent Application Publication
(10) Pub. No.: US 2026/0322275 A1
(43) Pub. Date: Oct. 15, 2026

(54) POWER CONVERSION TOPOLOGY WITH CURRENT DOUBLER RECTIFIER

(71) Applicant: Flex Ltd., Singapore (SG)

(72) Inventor: HONGSHAN TAO, Shanghai (CN)

(73) Assignee: Flex Ltd., Singapore (SG)

(21) Appl. No.: 19/235,366

(22) Filed: Jun. 11, 2025

(30) Foreign Application Priority Data
Apr. 14, 2025 (CN) 202510461773.8

(51) Int. Cl. H02M 3/335; H02M 1/14; H02M 3/00

(52) U.S. Cl. CPC H02M 3/33507; H02M 1/14; H02M 3/003; H02M 3/33573; H02M 3/33592

(57) ABSTRACT

Embodiments of the present disclosure are directed to apparatuses, power converters, and systems using current doubler rectifiers. According to one embodiment, an apparatus can comprise a transformer comprising a primary winding and one or more secondary windings, wherein the primary winding can comprise a portion of a power circuit; and a current doubler rectifier connected in parallel with the one or more secondary windings of the transformer, wherein an output voltage can be provided by the current doubler rectifier.

### CROSS-REFERENCE TO RELATED APPLICATIONS

The present application claims the benefit of and priority to Chinese Patent Application No. 202510461773.8 filed Apr.14, 2025, the entire disclosure of which is hereby incorporated by reference for all that it teaches and for all purposes.

### FIELD

The present disclosure is generally directed to power converters and more particularly directed to a Direct Current (DC)-to-DC power converter with a current doubler rectifier.

### BRIEF SUMMARY

Embodiments of the present disclosure are directed to apparatuses, power converters, and systems using current doubler rectifiers. According to one embodiment, an apparatus can comprise a transformer comprising a primary winding and one or more secondary windings, wherein the primary winding can comprise a portion of a power circuit; and a current doubler rectifier connected in parallel with the one or more secondary windings of the transformer, wherein an output voltage can be provided by the current doubler rectifier.

According to one aspect of the apparatus, the current doubler rectifier can comprise a first output inductor and a second output inductor.

According to one aspect of the apparatus, the first output inductor and the second output inductor can comprise separate inductors having separate cores.

According to one aspect of the apparatus, the first output inductor and the second output inductor can be connected in series.

According to one aspect of the apparatus, the first output inductor and the second output inductor can comprise coupled inductors having a common core.

According to one aspect of the apparatus, the output voltage provided by the current doubler rectifier can be provided between the first output inductor and the second output inductor.

According to another embodiment, a power converter can comprise a power circuit, a transformer comprising a primary winding and one or more secondary windings, wherein the primary winding comprises a portion of the power circuit, and a current doubler rectifier connected in parallel with the one or more secondary windings of the transformer, wherein an output voltage of the power converter can be provided by the current doubler rectifier.

According to one aspect of the power converter, the current doubler rectifier can comprise a first output inductor and a second output inductor.

According to one aspect of the power converter, the first output inductor and the second output inductor can comprise separate inductors having separate cores.

According to one aspect of the power converter, the first output inductor and the second output inductor can be connected in series.

According to one aspect of the power converter, the first output inductor and the second output inductor can comprise coupled inductors having a common core.

According to one aspect of the power converter, the output voltage provided by the current doubler rectifier can be provided between the first output inductor and the second output inductor.

According to another embodiment, a system can comprise a Direct Current (DC)-to-DC power converter providing and output voltage to at least a portion of the system. The DC-to-DC power converter can comprise a power circuit, a transformer comprising a primary winding and one or more secondary windings, wherein the primary winding comprises a portion of the power circuit, and a current doubler rectifier connected in parallel with the one or more secondary windings of the transformer, wherein the output voltage of the DC-to-DC power converter can be provided by the current doubler rectifier.

According to one aspect of the system, the current doubler rectifier can comprise a first output inductor and a second output inductor.

According to one aspect of the system, the first output inductor and the second output inductor can comprise separate inductors having separate cores.

According to one aspect of the system, the first output inductor and the second output inductor can be connected in series.

According to one aspect of the system, the first output inductor and the second output inductor can comprise coupled inductors having a common core.

### BRIEF DESCRIPTION OF THE DRAWINGS

FIG. 1 is a block diagram representing a schematic configuration of a conventional isolated Direct Current (DC)-to-DC power converter.

FIG. 2 is a circuit diagram representing a schematic configuration of a non-isolated DC-to-DC power converter with interconnected transformer windings.

FIG. 3 is a circuit diagram representing a schematic configuration of a DC-to-DC power converter with a current doubler rectifier according to one embodiment of the present disclosure.

FIG. 4 is a circuit diagram representing a schematic configuration of a DC-to-DC power converter with a current doubler rectifier according to another embodiment of the present disclosure.

FIG. 5 is a diagram illustrating an exemplary coupled inductor according to one embodiment of the present disclosure.

In the appended figures, similar components and/or features may have the same reference label. Further, various components of the same type may be distinguished by following the reference label by a letter that distinguishes among similar components. If only the first reference label is used in the specification, the description is applicable to any one of the similar components having the same first reference label irrespective of the second reference label.

### DETAILED DESCRIPTION

The subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the subject matter may be practiced without these specific details. In other instances, well-known structures and devices are shown in block diagram form in order to facilitate describing the subject innovation.

Moreover, the word “exemplary” is used herein to mean serving as an example, instance, or illustration. Any aspect or design described herein as “exemplary” is not necessarily to be construed as preferred or advantageous over other aspects or designs. Rather, use of the word “exemplary” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. In addition, the word “coupled” is used herein to mean direct or indirect electrical or mechanical coupling.

One embodiment of the present disclosure described herein pertains to a Direct Current (DC)-to-DC power converter that might be used to deliver power at a low DC voltage from a source having a high DC voltage. The term “converter,” as used herein, encompasses but is not limited to any one of, or any combination of “regulator,” “DC regulator,” “voltage regulator,” “DC voltage regulator,” DC-to-DC converter,” “DC converter” and “converter,” and includes, but is not limited to, the plain meaning of any of these terms.

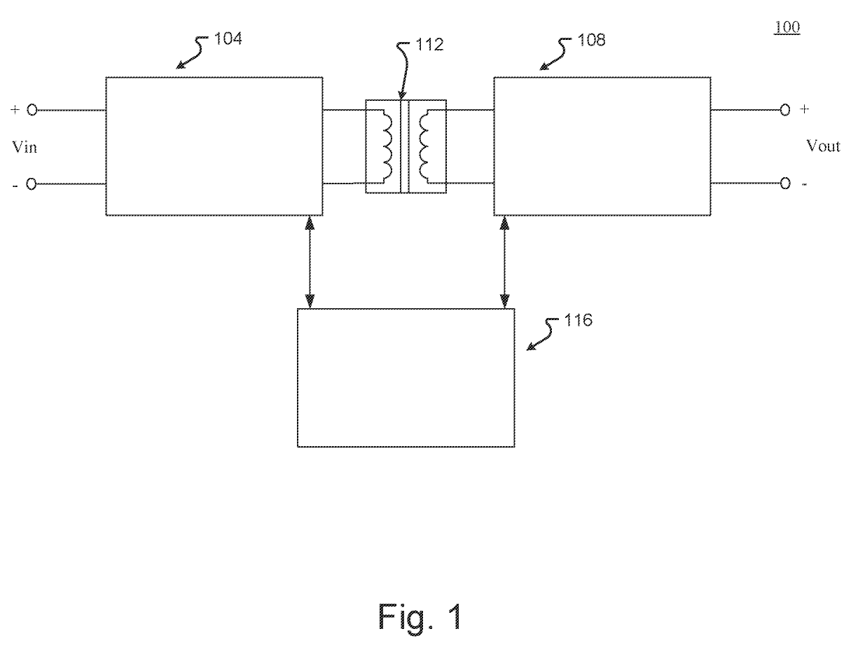

FIG. 1 is a block diagram representing a schematic configuration of a conventional isolated DC-to-DC power converter 100. An isolated power converter isolates the input from the output by electrically and physically separating the circuit for the power converter into two sections preventing direct current flow between the input and output, typically achieved by using a transformer. The power converter 100 generally includes a primary side 104 which includes one or more power circuit switching elements (not shown). The primary side 104 may receive an input voltage from a voltage source Vin. The power converter 100 also includes a secondary side 108 which may include a rectification circuit, a filter circuit and a load (not shown), for example. The secondary side 108 outputs an output voltage Vout. The secondary side 108 is isolated from the primary side by a transformer 112 having one or more primary windings and one or more secondary windings for example. The power converter 100 also includes control circuitry 116 for controlling the power converter 100 by determining when the one or more power circuit switching elements will be turned ON and OFF. The control circuitry 116 typically senses voltages and currents at the input, at the output, and/or within the power converter 100. With this topology of the conventional isolated DC-to-DC power converter 100, the current flowing in the primary side 104 is only circulating in the primary side 104 and the current flowing in the secondary side 108 is only circulating in the secondary side 108 due to the fact that each of the primary side 104 and the secondary side 108 has its own return or ground reference.

In conventional topologies, the transformer is typically needed for high voltage conversion ranges from the input to the output for good efficiency. Use of transformers, however, can cause large winding losses due to a large number of primary turns and high AC content in the secondary windings, which drives winding and printed circuit board costs.

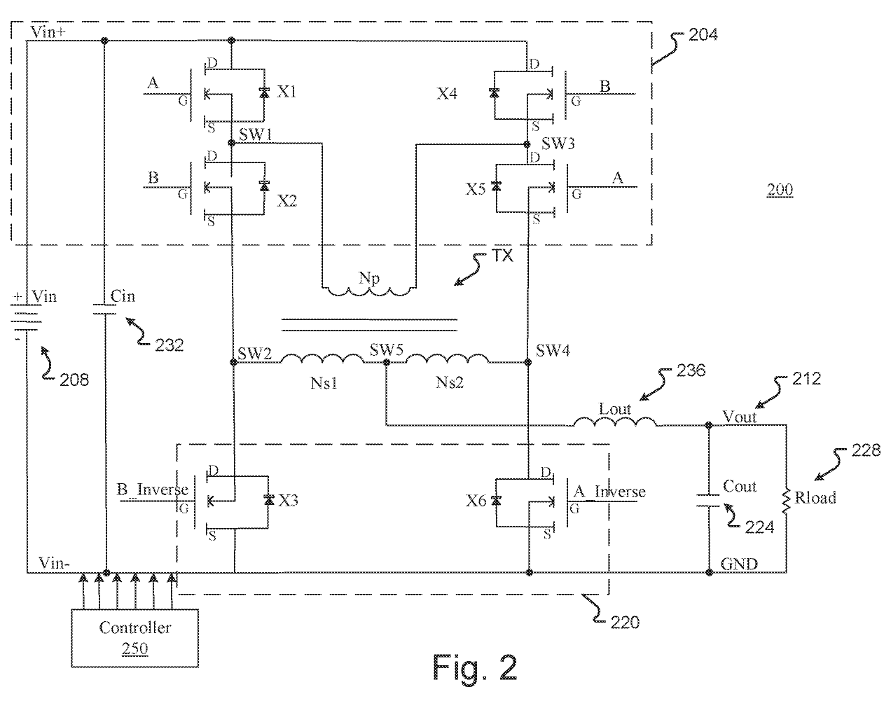

FIG. 2 is a circuit diagram representing a schematic configuration of a non-isolated DC-to-DC power converter with interconnected transformer windings. More specifically, this example illustrates a DC-to-DC power converter as described in U.S. Patent Application Number 17/477,734 filed September 17, 2021 by Appelberg and entitled “Non-Isolated Pulse Width Modulated (PWM) Full Bridge Power Converter with Interconnected Windings” which is now issued as U.S. Patent Number 11,967,905 and which is incorporated herein by reference in its entirety for all purposes. As described therein, the power converter 200 includes a power circuit 204 including power circuit switching elements. The power circuit switching elements include two series connected power circuit switching elements in parallel with two series connected power circuit switching elements; X1, X2, X4, X5 arranged in a full bridge configuration. The power circuit switching elements X1, X2, X4, X5 may include, for example, metal-oxide-semiconductor field-effect transistor (MOSFET)s or gallium nitride (GaN) FETs. The power circuit 204 also includes an input voltage source 208 providing a DC input voltage Vin to the power circuit switching elements X1, X2, X4, X5. The power circuit 204 is configured to produce a unipolar square-wave voltage.

The power converter 200 also includes an output voltage 212 for providing a converted DC voltage as output voltage Vout, a transformer TX, a rectification circuit 220, a filter circuit 224 and a load 228.

An input capacitor Cinis coupled in parallel between the input voltage source 208 and the power circuit switching elements X1, X2, X4, X5. Input capacitor Cin acts as a filter for the input voltage Vin and buffers the energy. The transformer TX includes a primary winding Np coupled to the power circuit switching elements X1, X2, X4, X5 and secondary windings Ns1 and Ns2 coupled to the rectification circuit 220 and an output inductor 236 Lout. The number of windings associated with each of the primary winding Np and the secondary windings Ns1 and Ns2 can be any suitable value and vary depending on the embodiment. The filter circuit 224 includes a capacitor Cout and the load 228 is symbolized by a resister R mounted in parallel to the filter circuit 224. The capacitor Cout is provided to smooth the rectified voltage to the load 228. The filter circuit 224 is mounted in parallel with the rectification circuit 220.

As illustrated in FIG. 2, the rectification circuit 220 includes two power circuit switching elements including a parallel diode X3, X6 arranged to provide synchronous rectification. Alternatively, the rectification circuit 220 can include more or less switching devices if desired and/or be configured without synchronous rectification.

Further in this example embodiment, the drain node (D) of the power circuit switching element X1 and the drain node (D) of the power circuit switching element X4 are connected to the input voltage source Vin. Further, the source node (S) of the power circuit switching element X1 is coupled to the drain node (D) of the power circuit switching element X2 (switch node SW1). The source node (S) of the power circuit switching element X4 is coupled to the drain node (D) of the power circuit switching element X5 (switch node SW2). The source node (S) of the power circuit switching element X2 is coupled to switch node SW2. The source node (S) of the power circuit switching element X5 is coupled to switch node SW4. The drain (D) of the power circuit switching element X3 is connected to switch node SW2; the source (S) of the power circuit switching element X3 is connected to ground. The drain (D) of the power circuit switching element X6 is connected to node SW4; the source (S) of the power circuit switching element X6 is connected to ground.

The power converter 200 of FIG. 2 includes one or more controller(s) 250 for generating control signals (e.g., pulse-width modulated (PWM) signals) for the power circuit switching elements X1, X2, X3, X4_{,} X5, X6. As illustrated in FIG. 2A, the control signal A controls the power circuit switching elements X1 and X5_{;} the control signal B controls the power circuit switching elements X2 and X4; the control signal A_Inverse controls the power circuit switching element X6; and the control signal B_Inverse controls the power circuit switching element X3. According to an alternative embodiment of the present disclosure, control signal A can be split into two control signals (A_X1 and A_X5) and control signal B can be split into two control signals (B_X2 and B_X4) for control reasons (e.g., compensate for delays in driving circuitry, different modulations during start-up, etc.) The controller 250 of FIG. 2 can include one or more gate drive circuits and/or other suitable drive circuits to generate control signals.

The controller 250 is adapted to vary the duty cycle of the control signals (e.g., A, B, A_Inverse, B_Inverse) to regulate the output voltage Vout. In general, the frequency is normally kept constant, but the frequency can be modulated to reduce current ripple. As illustrated in FIG. 2, the power circuit switching elements X1, X2, X4, X5 are shunt or clamped by their intrinsic capacitance and by their intrinsic body diodes. As also illustrated in FIG. 2, the power circuit switching elements X3, X6 are shunt or clamped by their intrinsic output capacitance and by their intrinsic body diodes.

In the non-isolated embodiment, a common ground (e.g., GND) is provided for the entire circuit of the power converter 200. As such, the secondary windings Ns1, Ns2 are made part of (e.g., interconnected with) the primary winding Np. With this arrangement, several benefits can be achieved. According to embodiments of the present disclosure, regulation of the voltage and the elimination of a capacitive divider section are achieved. According to embodiments of the present disclosure in the charging phase, the primary winding Np is connected in series with both ends of the secondary winding Ns1, Ns2 depending on which phase of the power converter 200 conducts.

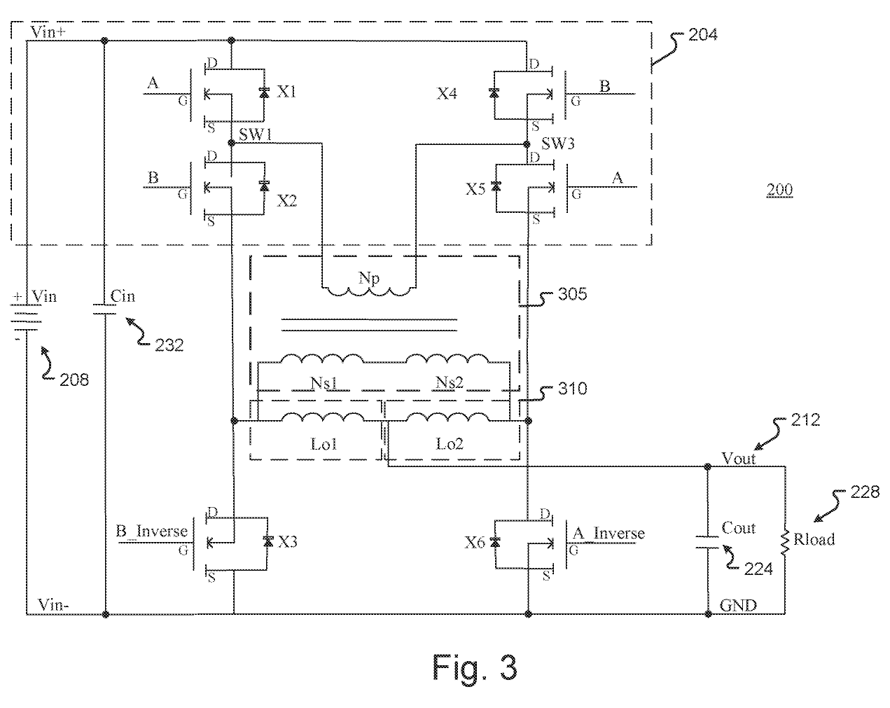

FIG. 3 is a circuit diagram representing a schematic configuration of a DC-to-DC power converter with a current doubler rectifier according to one embodiment of the present disclosure. This example illustrates a power converter 200 such as described above with reference to FIG. 2. However, in this example, the transformer 305, i.e., (Tx) as described above, is coupled with a current doubler rectifier 310. More specifically, rather than the output inductor 236 electrically coupled with the secondary windings (NS1 and Ns2) of the transformer as described above and the output voltage 212 being provided by the output inductor 236, the output voltage is provided by the current doubler rectifier 310.

Stated another way, the power converter 200 can comprise a power circuit 204 and a transformer 305 as described above. Also as described above, the transformer 305 can comprise a primary winding (Np) and one or more secondary windings (Ns1 and Ns2) with the primary winding (Np) comprising a portion of the power circuit 204. The current doubler rectifier 310 can be connected in parallel with the one or more secondary windings (Ns1 and Ns2) of the transformer 305. The output voltage 212 of the power converter can be provided by the current doubler rectifier 310.

The current doubler rectifier 310 can comprise a first output inductor (Lo1) and a second output inductor (Lo2). For example, and as illustrated in FIG. 3, the first output inductor (Lo1) and the second output inductor (Lo2) can comprise separate inductors having separate cores. In such cases, the first output inductor (Lo1) and the second output inductor (Lo2) can be connected in series. The output voltage 212 provided by the current doubler rectifier 310 can be provided or obtained at a point between the first output inductor (Lo1) and the second output inductor (Lo2).

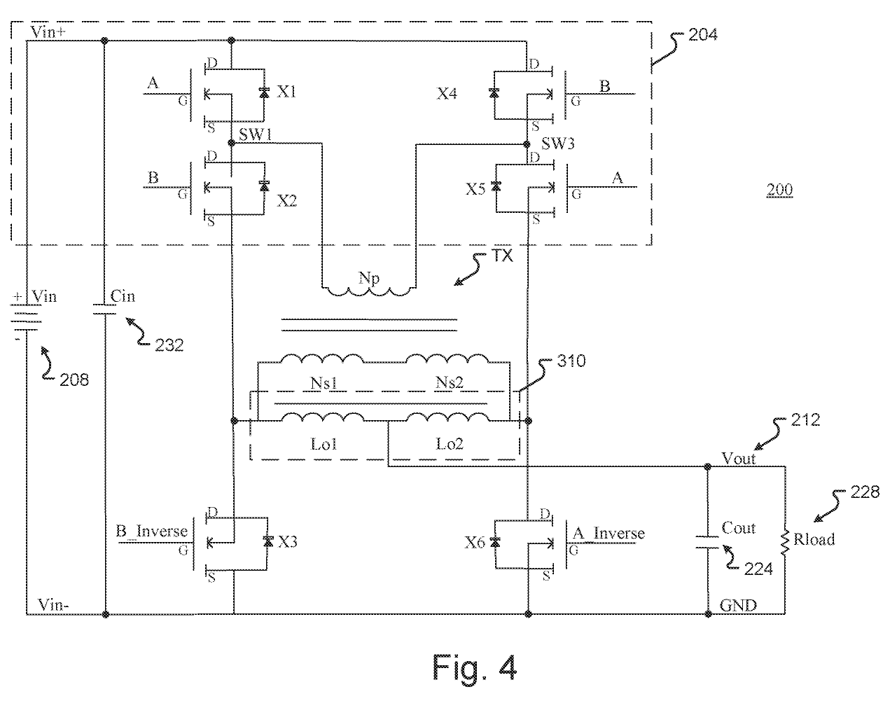

FIG. 4 is a circuit diagram representing a schematic configuration of a non-isolated DC-to-DC power converter with a current doubler rectifier according to another embodiment of the present disclosure. As with the example illustrated in FIG. 3 and described above, this example also illustrates a power converter 200 in which the transformer 305 is coupled with a current doubler rectifier 310. As described above, the transformer 305 can comprise a primary winding (Np) and one or more secondary windings (Ns1 and Ns2) with the primary winding (Np) comprising a portion of the power circuit 204. The current doubler rectifier 310 can be connected in parallel with the one or more secondary windings (Ns1 and Ns2) of the transformer 305. The output voltage 212 of the power converter can be provided by the current doubler rectifier 310.

As with the previous example, the current doubler rectifier 310 can comprise a first output inductor (Lo1) and a second output inductor (Lo2). For example, and as illustrated in FIG. 3, the first output inductor (Lo1) and the second output inductor (Lo2) can comprise separate inductors having separate cores. In such cases, the first output inductor (Lo1) and the second output inductor (Lo2) can be connected in series. However, as illustrated in the example of FIG. 4, the first output inductor (Lo1) and the second output inductor (Lo2) can comprise coupled inductors having a common core. Once again, the output voltage 212 provided by the current doubler rectifier 310 can be provided or obtained at a point between the first output inductor (Lo1) and the second output inductor (Lo2).

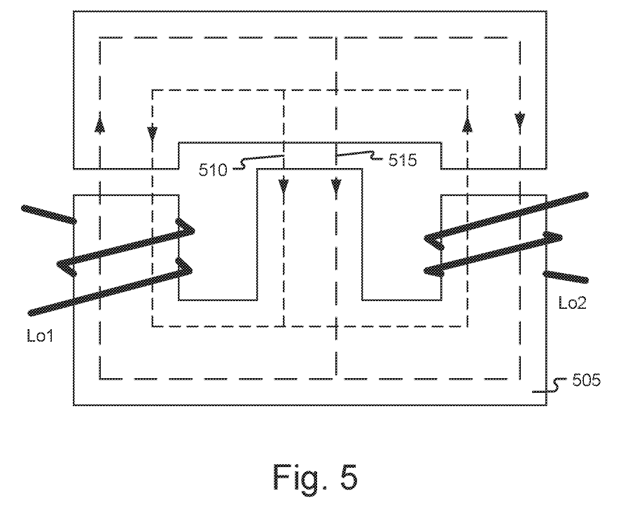

FIG. 5 is a diagram illustrating an exemplary coupled inductor according to one embodiment of the present disclosure. More specifically, this example illustrates another view of the common core 505 of the first output inductor (Lo1) and the second output inductor (Lo2) of the current doubler rectifier 310 as described above with reference to FIG. 4. Also illustrated here are the inductive flows 510 and 515 induced by the first output inductor (Lo1) and the second output inductor (Lo2) respectively. By the first output inductor (Lo1) and the second output inductor (Lo2) being coupled together with one core 505 core losses can be reduced by flux cancellation.

Regardless of whether the first output inductor (Lo1) and the second output inductor (Lo2) are implemented as separate inductors having separate cores as illustrated in FIG. 3 or as inductors sharing a common core, embodiments described herein provide for smaller RMS currents in the windings of the transformer 305 of the power converter 200 compared to previous power converters. Embodiments also provide lower current stress in output inductors, better load transient, lower core loss by coupling for output inductors, and higher power conversion efficiency compared to prior power converters.

The exemplary devices, systems and methods of this disclosure have been described in relation to a power converter. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The terms “determine,” “calculate,” “compute,” and variations thereof, as used herein, are used interchangeably and include any type of methodology, process, mathematical operation or technique.

The present disclosure, in various aspects, embodiments, and/or configurations, includes components, methods, processes, systems, and/or apparatus substantially as depicted and described herein, including various aspects, embodiments, configurations embodiments, sub-combinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. An apparatus, comprising:
a transformer comprising a primary winding and one or more secondary windings, wherein the primary winding comprises a portion of a power circuit; and
a current doubler rectifier connected in parallel with the one or more secondary windings of the transformer, wherein an output voltage is provided by the current doubler rectifier.

2. The apparatus of claim 1, wherein the current doubler rectifier comprises a first output inductor and a second output inductor.

3. The apparatus of claim 2, wherein the first output inductor and the second output inductor comprise separate inductors having separate cores.

4. The apparatus of claim 3, wherein the first output inductor and the second output inductor are connected in series.

5. The apparatus of claim 2, wherein the first output inductor and the second output inductor comprise coupled inductors having a common core.

6. The apparatus of claim 2, wherein the output voltage provided by the current doubler rectifier is provided between the first output inductor and the second output inductor.

7. A power converter comprising:
a power circuit;
a transformer comprising a primary winding and one or more secondary windings, wherein the primary winding comprises a portion of the power circuit; and
a current doubler rectifier connected in parallel with the one or more secondary windings of the transformer, wherein an output voltage of the power converter is provided by the current doubler rectifier.

8. The power converter of claim 7, wherein the current doubler rectifier comprises a first output inductor and a second output inductor.

9. The power converter of claim 8, wherein the first output inductor and the second output inductor comprise separate inductors having separate cores.

10. The power converter of claim 9, wherein the first output inductor and the second output inductor are connected in series.

11. The apparatus of claim 8, wherein the first output inductor and the second output inductor comprise coupled inductors having a common core.

12. The power converter of claim 8, wherein the output voltage provided by the current doubler rectifier is provided between the first output inductor and the second output inductor.

13. A system comprising:
a Direct Current (DC)-to-DC power converter providing and output voltage to at least a portion of the system, the DC-to-DC power converter comprising:
a power circuit;
a transformer comprising a primary winding and one or more secondary windings, wherein the primary winding comprises a portion of the power circuit; and
a current doubler rectifier connected in parallel with the one or more secondary windings of the transformer, wherein the output voltage of the DC-to-DC power converter is provided by the current doubler rectifier.

14. The system converter of claim 13, wherein the current doubler rectifier comprises a first output inductor and a second output inductor.

15. The system converter of claim 14, wherein the first output inductor and the second output inductor comprise separate inductors having separate cores.

16. The system converter of claim 15, wherein the first output inductor and the second output inductor are connected in series.

17. The system of claim 14, wherein the first output inductor and the second output inductor comprise coupled inductors having a common core.
